(19) United States
(12) Patent Application Publication
(10) Pub. No.: US 2026/0261527 A1
(43) Pub. Date: Sep. 3, 2026

(54) SPECULATIVE-EXECUTION-BASED STATEFUL PROGRAMMABLE DATA PLANE STRUCTURE AND CHIP

(71) Applicant: TSINGHUA UNIVERSITY, Beijing (CN)

(72) Inventors: Bin LIU, Beijing (CN); Zhikang CHEN, Beijing (CN); Yong FENG, Beijing (CN)

(21) Appl. No.: 19/654,520

(22) Filed: Apr. 22, 2026

Related U.S. Application Data
(63) Continuation of application No. PCT/CN2024/091773, filed on May 8, 2024.

(30) Foreign Application Priority Data
Mar. 27, 2024 (CN) 202410360790.8

(51) Int. Cl. H04L 49/00; H04L 45/745; H04L 47/62; H04L 49/109

(52) U.S. Cl. CPC H04L 49/3063; H04L 45/74591; H04L 47/621; H04L 49/109

(57) ABSTRACT

A speculative-execution-based stateful programmable data plane structure and a chip are provided. The data plane structure includes: stage processors forming a pipeline for data processing, each stage processor being configured to process one pipeline stage; a side ring including ring nodes connected to the stage processors in one-to-one correspondence; a read processor configured to read a state required to be read of a stateful packet; and a write processor configured to write a state required to be written of the stateful packet, identify a packet having a state modified and requiring resubmission, upload the packet requiring resubmission to the ring node corresponding to the write processor, and transmit the packet requiring resubmission through the side ring to a ring node corresponding to a read processor. The read processor is further configured to download the packet requiring resubmission from the corresponding ring node.

### CROSS-REFERENCE TO RELATED APPLICATION

This application is a continuation of International Application No. PCT/CN2024/091773, titled "SPECULATIVE-EXECUTION-BASED STATEFUL PROGRAMMABLE DATA PLANE STRUCTURE AND CHIP", filed on May 08, 2024, which is based on and claims priority to Chinese Patent Application No. 202410360790.8, filed on March 27, 2024, which is incorporated herein by reference in its entirety.

### FIELD

The present disclosure relates to the technical field of programmable data planes, and more particularly, to a speculative-execution-based stateful programmable data plane structure and a chip.

### BACKGROUND

A programmable switch includes a programmable data plane and a control plane. The data plane is responsible for protocol parsing and deparsing, and packet processing. The control plane is responsible for issuing parsing rules and lookup table matching rules. From customized protocol forwarding to supporting in-network computing applications, high-performance programmable switch chips further tap into the potential of data plane devices. The demand for high throughput has made hardware pipelines the primary architectural choice for switch chips. Although pipelines offer unparalleled throughput, they assume a forward processing flow, which hinders effective support for stateful functions critical to many valuable applications.

Stateful data plane functions can be summarized as Extended Finite State Machine (EFSM). A state of a packet is read from a flow state table. A corresponding operation is executed based on a current state and input. The operation may result in a state update, which is then written back to the flow state table. A conflict between the operation of writing the state update back to the flow state table and the forward processing flow of the pipeline makes existing pipeline techniques incapable of supporting relatively complex stateful operations.

### SUMMARY

The present disclosure provides a speculative-execution-based stateful programmable data plane structure and a chip, to solve problems in the related technology that pipeline techniques are incapable of supporting relatively complex stateful operations and incur high development costs.

According to an embodiment of a first aspect of the present disclosure, a speculative-execution-based stateful programmable data plane structure is provided, including: a plurality of stage processors forming a pipeline for data processing, each of the plurality of stage processors being configured to process one pipeline stage; and a side ring including a plurality of ring nodes. The plurality of ring nodes are connected to the plurality of stage processors in one-to-one correspondence. Any of the plurality of stage processors is configurable as the read processor or the write processor. The read processor is configured to read a state required to be read of at least one stateful packet and speculate that the state of the stateful packet remains unchanged. The write processor is configured to write a state required to be written of the stateful packet, identify a packet having a state modified and requiring resubmission, upload the packet requiring resubmission to the ring node corresponding to the write processor, and transmit the packet requiring resubmission through the side ring to the ring node corresponding to the read processor. The read processor is further configured to download the packet requiring resubmission from the corresponding ring node.

In an embodiment, each of the plurality of stage processors includes a configurable scheduler module. The configurable scheduler module of the read processor is configured as a read scheduler module. The configurable scheduler module of the write processor is configured as a write scheduler module. The configurable scheduler module of a stage processor among the plurality of stage processors other than the read processor and the write processor is not activated.

In an embodiment, each of the read scheduler module and the write scheduler module includes: a dirty table stored in a content-addressable memory, a key for matching in the dirty table being a state table index of a flow. The dirty table of the write scheduler module includes a table of keys, and the dirty table of the read scheduler module includes a table of keys and corresponding data. The write scheduler module is configured to write a flow corresponding to the packet having the state modified into the dirty table, and transmit a write-back control signal through the side ring to the read scheduler module. The read scheduler module is configured to write the flow corresponding to the packet having the state modified into the dirty table based on the write-back control signal.

In an embodiment, the read processor further includes: a resubmission buffer configured to store a resubmitted packet. The read scheduler module further includes: a packet buffer configured to store a packet that hits the dirty table, in which a packet of each flow is linked in a first linked list and a second linked list, the first linked list being configured to store a packet newly arrived on the pipeline, and the second linked list being configured to store the packet requiring resubmission; and an order-preserving checking module configured to schedule a packet in the packet buffer, and detect, in response to the packet in the packet buffer being scheduled, whether all packets requiring resubmission of a flow to which the packet to be scheduled belongs have already arrived at the resubmission buffer and have been moved to the second linked list of the packet buffer.

In an embodiment, the order-preserving checking module is further configured to: start a timer, and determine whether all the packets requiring resubmission have already arrived at the resubmission buffer until the timer expires.

In an embodiment, a bus of the side ring is configured with a heartbeat address field. The heartbeat address field is independent of other fields on the bus. Each pipeline stage occupies one bit of the heartbeat address field, and writes a signal carrying a heartbeat into the heartbeat address field. The timer is configured to advance by one time unit in response to receiving the signal carrying the heartbeat transmitted from the corresponding write processor.

In an embodiment, the order-preserving checking module is further configured to: write, when a state of each packet is read, a sequence number of the packet into a counter table; and determine, in response to a sequence number of the packet requiring resubmission equaling the sequence number in the counter table, that all the packets requiring resubmission have already arrived at the resubmission buffer.

In an embodiment, the read processor is further configured to write, in response to a packet of a flow in the packet buffer starting to be scheduled, a purge signal into the corresponding ring node, where the purge signal is transmitted through the side ring to the ring node corresponding to the write processor, and is downloaded to the write processor. The write processor is further configured to remove a corresponding flow from the dirty table based on the purge signal.

In an embodiment, the read scheduler module includes first to third levels of state consistency. The first level of state consistency includes that: a read operation on a packet occurs subsequent to write operations on all packets prior to the packet. The second level of state consistency includes that: for a flow to which a target packet belongs, read operations on K packets following the target packet are allowed to occur prior to write operations on the K packets, and starting from a (K+1)th packet, a read operation on a packet occurs subsequent to write operations on all packets prior to the packet. The third level of state consistency includes that: an order between a read operation and a write operation on a packet is arbitrary.

According to an embodiment of a second aspect of the present disclosure, a programmable switch chip is provided, including the speculative-execution-based stateful programmable data plane structure according to any one of the above embodiments.

Thus, the present disclosure includes the following beneficial effects.

In the embodiments of the present disclosure, a simple side ring is added to the pipeline, and each pipeline stage is connected to the side ring. A data flow on the side ring is in an opposite direction to that of the pipeline, providing a fast backward communication path. The read processor reads the state required to be read of the stateful packet. When the write processor writes back a packet requiring state modification, the state can be written back across stages. The entire process is very convenient and more efficient, and supports complex stateful functions, reducing development, deployment, and maintenance costs of in-network computing applications as a whole. Thus, the problems in the related technology that the pipeline techniques are unable to support the relatively complex stateful operations and incur the high development costs are solved.

Additional aspects and advantages of the present disclosure will be provided at least in part in the following description, or will become apparent in part from the following description, or can be learned from the practice of the present disclosure.

### BRIEF DESCRIPTION OF THEDRAWINGS

The above and/or additional aspects and advantages of the present disclosure will become more apparent and more understandable from the following description of embodiments taken in conjunction with the accompanying drawings.

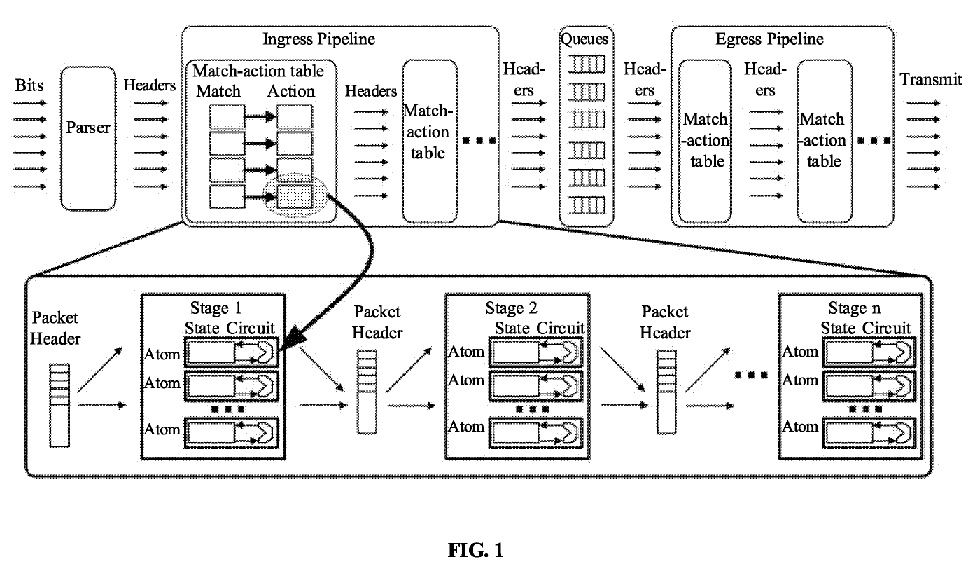

FIG. 1 illustrates the Banzai architecture in the related technology.

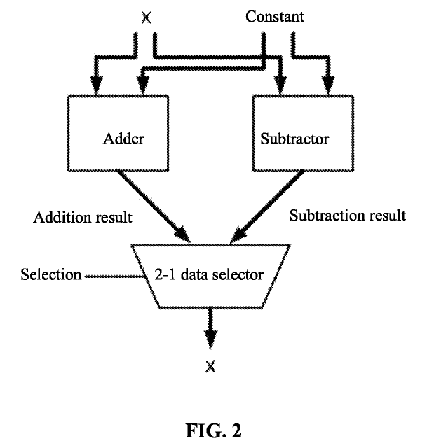

FIG. 2 is a circuit diagram of atomic actions in Banzai in the related technology.

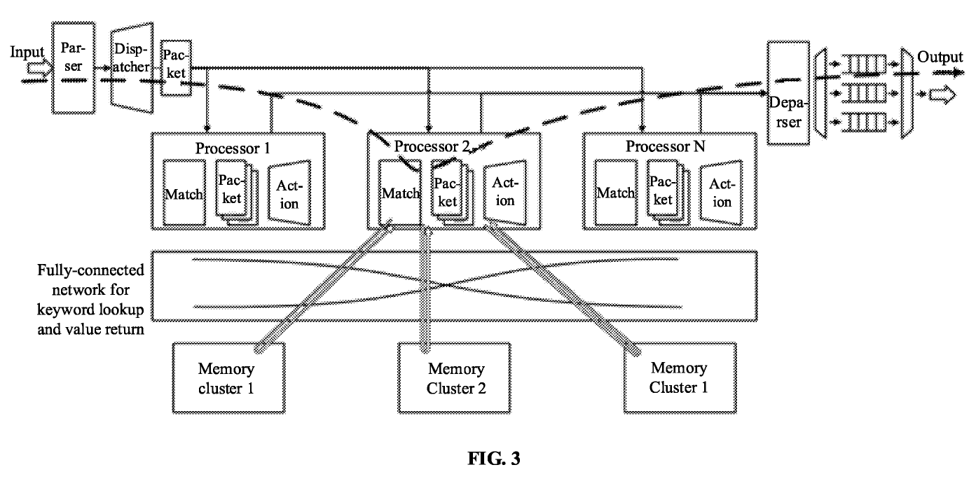

FIG. 3 is a schematic diagram of the technical architecture of a disaggregated Reconfigurable Match Table (dRMT) in the related technology.

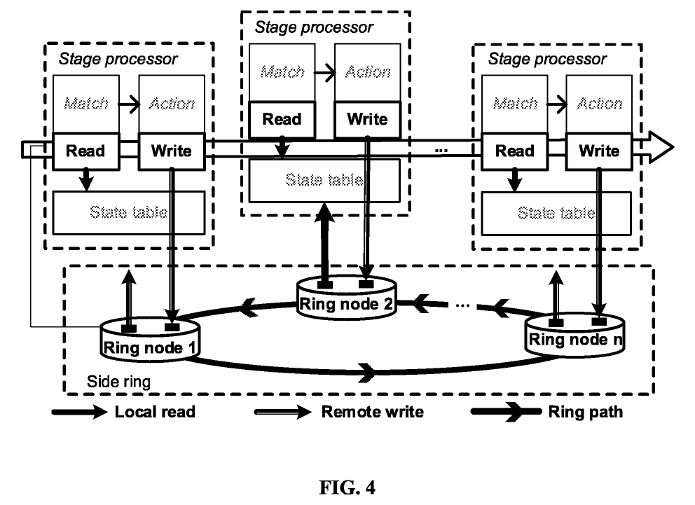

FIG. 4 is a block diagram of a speculative-execution-based stateful programmable data plane structure according to an embodiment of the present disclosure.

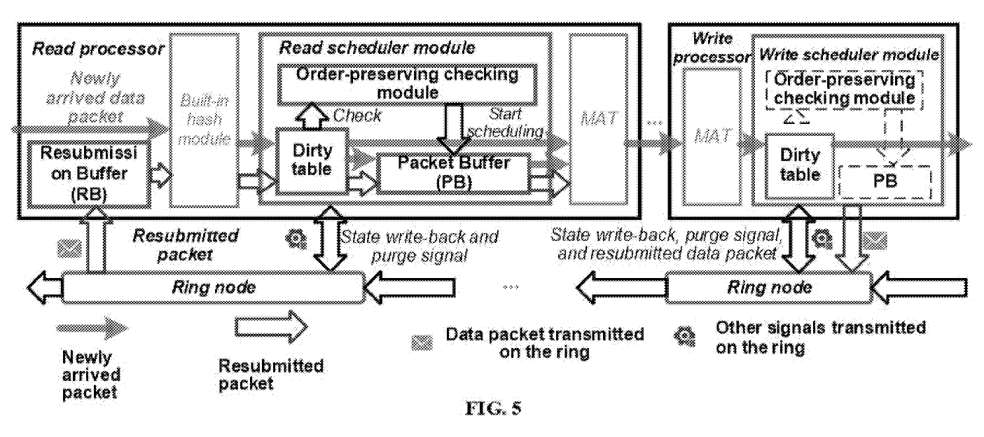

FIG. 5 is a schematic structural diagram of a scheduler module according to an embodiment of the present disclosure.

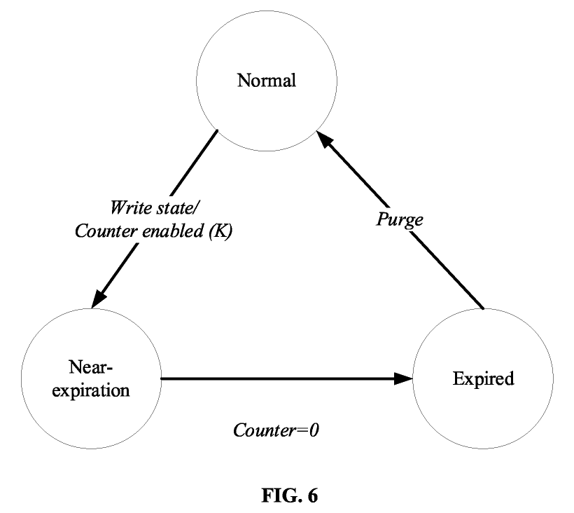

FIG. 6 is a schematic diagram of a Finite State Machine (FSM) under bounded staleness consistency according to an embodiment of the present disclosure.

### DETAILED DESCRIPTION

The embodiments of the present disclosure will be described in detail below with reference to examples thereof as illustrated in the accompanying drawings, throughout which the same or similar elements, or elements having the same or similar functions, are denoted by the same or similar reference numerals. The embodiments described below with reference to the drawings are illustrative only, and are intended to explain rather than limit the present disclosure.

A speculative-execution-based stateful programmable data plane structure and a chip according to embodiments of the present disclosure will be described below with reference to the accompanying drawings. In response to the problems mentioned in the above background, the present disclosure provides the speculative-execution-based stateful programmable data plane structure, where a simple side ring is added to a pipeline, and each pipeline stage is connected to the side ring. A data flow on the side ring is in an opposite direction to that of the pipeline, providing a fast backward communication path. A read processor reads a state required to be read of a stateful packet. When a write processor writes back a packet requiring a state modification, the state can be written back across stages. The entire process is very convenient and more efficient, and supports complex stateful functions, reducing development, deployment, and maintenance costs of in-network computing applications as a whole. Thus, problems in the related technology that pipeline techniques are incapable of supporting relatively complex stateful operations and incur high development costs are solved.

Before introducing the present disclosure, technologies related to the present disclosure are explained in detail as follows.

1. First related technology

As illustrated in FIG. 1, Banzai is a technical prototype of programmable switch Tofino launched by Intel. A user programs protocols and functions on Tofino by using a protocol-independent language, and operates on lookup tables and state tables on a chip through runtime software provided by Intel. As illustrated in FIG. 1, when a packet enters Banzai, Banzai parses out a header field of the packet through a programmable parser and processes the header through two pipelines including an ingress pipeline and an egress pipeline. The two pipelines with the same structure constitute a programmable packet processing logic of Banzai. Each of the two pipelines is composed of a series of stages, namely, Match-Action Tables (MATs), which are basic programmable units of this prototype. The user programs the MAT through a protocol-independent language in two aspects: what lookup table should be queried for the packet at this stage, and what processing logic should be executed after the query result is obtained.

A processing logic for each stage in Banzai is performed using a set of parallel atomic actions. A circuit used for the atomic actions is illustrated in FIG. 2. The atomic action can perform a “read-add/subtract-writeback” function. An operand of the atomic action can be a field in the header of the packet or a register in a state table. However, due to simplicity of the atomic action, only a simple stateful function (such as a counter) can be achieved through the atomic action. For a relatively complex function, a logic to determine a next state may involve a series of actions and table access, which cannot be achieved through the atomic action. In order to avoid a bottleneck in the pipeline, this solution cannot support these stateful functions by simply expanding the atomic action circuit and enhancing the function of the atomic action. Due to unidirectionality of the pipeline, there is no effective mechanism to write state data back to an early stage. The only approach is recirculation, i.e., the packet is resent to the head of the pipeline to be processed again, but this approach may disrupt the order of packets from the same flow within the pipeline, resulting in unavoidable Write-After-Read (WAR) conflicts and causing state consistency issues (i.e., reading a stale state).

2. Second related technology

dRMT employs a multicore and multithreaded Run-To-Complete (RTC) processor to support stateful functions. dRMT decouples a memory from a processor on a switch chip, allowing the processor to access memory resources within a memory cluster through a switching network, as illustrated in FIG. 3. If dRMT uses a shared memory to store state tables, state consistency issues need to be handled through access scheduling and locking, leading to unpredictable waiting time on some processors. Therefore, an assumed premise of deterministic latency of an integer linear programming-based compilation algorithm of dRMT is undermined, rendering such programs uncompilable. If each processor maintains a respective copy of the state table, complex synchronization mechanisms are required and substantial additional memory is consumed.

3. Third related technology

FlowBlaze uses queues and a scheduling mechanism to ensure state consistency. At each stage of FlowBlaze, an independent flow context table is queried for a packet to determine whether a flow to which the packet belongs is being processed at a current stage. Once a packet enters a processing flow of a stateful function (matching and executing operations on an EFSM table), FlowBlaze blocks subsequent packets from the same flow, ensuring state consistency. The approach adopted by FlowBlaze effectively assumes that all packets entering the stateful function are likely to have the state modified, which could cause pipeline stalls and thus create performance bottlenecks. But in reality, the stateful function may only apply to a subset of flows, different flows under stateful processing may access different states, and packets within the same flow may not have states modified, such that consecutive packets are unlikely to have the same state read and updated. Further, the additional flow context table and a scheduler module cause FlowBlaze to occupy a large chip area, and FlowBlaze cannot support more complex stateful functions that cannot be accomplished by a single EFSM table.

FIG. 4 is a block diagram showing a speculative-execution-based stateful programmable data plane structure according to an embodiment of the present disclosure.

As illustrated in FIG. 4, the speculative-execution-based stateful programmable data plane structure includes a plurality of stage processors, a side ring, a plurality of ring nodes, and so on.

The plurality of stage processors form a pipeline for data processing. Each stage processor is configured to process one pipeline stage. The side ring includes a plurality of ring nodes. The plurality of ring nodes are connected to the plurality of stage processors in one-to-one correspondence. Any of the plurality of stage processors is configurable as a read processor or a write processor. The read processor is configured to read a state required to be read of at least one stateful packet and speculate that the state of the stateful packet remains unchanged. The write processor is configured to write a state required to be written of a stateful packet, identify a packet having a state modified and requiring resubmission, upload the packet requiring resubmission to the ring node corresponding to the write processor, and transmit the packet requiring resubmission through the side ring to the ring node corresponding to the read processor. The read processor is further configured to download the packet requiring resubmission from the corresponding ring node.

In an embodiment of the present disclosure, each of the plurality of stage processors includes a configurable scheduler module. The configurable scheduler module of the read processor is configured as a read scheduler module. The configurable scheduler module of the write processor is configured as a write scheduler module. The configurable scheduler module of a stage processor among the plurality of stage processors other than the read processor and the write processor is not activated.

It should be understood that the embodiments of the present disclosure provide a low-cost, high-performance data plane architecture that supports cross-stage data write-back: Ring-Augmented Pipeline Dataplane (RAPID). An overall technical architecture of RAPID is illustrated in FIG. 4. In RAPID, according to an embodiment of the present disclosure, a simple side ring may be added to a pipeline, and each pipeline stage is connected to the side ring. In an embodiment, a data flow on the side ring may be in an opposite direction to that of the pipeline, providing a fast backward communication path. In an embodiment, the data flow on the side ring may be in the same direction as the pipeline. In an embodiment, the side ring may be a bidirectional data path, i.e., data may flow bidirectionally between adjacent nodes. A specific choice or setting can be made by those skilled in the art, and is not limited in the present disclosure.

Further, the embodiments of the present disclosure provide a “local read-remote write” behavior abstraction in RAPID. A complex stateful function involves a series of stage processors in the pipeline. The flow state table is stored on the first one of the processors in the series. The state of the packet is read on the first processor, and the state is written back across stages on the last one of the processors in the series after processing through several processors. A control signal, an address, and data that are written back across stages are uploaded by the last processor to the ring node corresponding to the last processor, transmitted via the side ring to the ring node corresponding to the first processor, and subsequently written into the state table stored on the first processor.

To ensure state consistency, the configurable scheduler module is mounted on each stage processor according to an embodiment of the present disclosure, as illustrated in FIG. 5. This module is reconfigurable into the read scheduler module or the write scheduler module based on a user program. In a series of processors for “local read-remote write,” the scheduler module on the read processor is configured as the read scheduler module, the scheduler module on the write processor is configured as the write scheduler module, and the scheduler modules on intermediate processors are not activated. Leveraging the data prefetching technology, the scheduler module is implemented as a bypass without being inserted into the pipeline, and thus the activated scheduler module introduces no additional latency to pipeline processing. When the user program does not require cross-stage data write-back, the scheduler module and the side ring connected to the scheduler module do not impact pipeline performance.

Further, according to an embodiment of the present disclosure, each of the read scheduler module and the write scheduler module includes: a dirty table stored in a content-addressable memory. A key for matching in the dirty table is a state table index of a flow. The dirty table of the write scheduler module includes a table of keys. The dirty table of the read scheduler module includes a table of keys and corresponding data. The write scheduler module is configured to write a flow corresponding to the packet having the state modified into the dirty table, and transmit a write-back control signal through the side ring to the read scheduler module. The read scheduler module is configured to write the flow corresponding to the packet having the state modified into the dirty table based on the write-back control signal.

It should be understood that each of the read scheduler module and the write scheduler module according to the embodiment of the present disclosure is equipped with a small content-addressable memory as the dirty table for registering a “dirty” flow currently ongoing stateful processing. The key for matching in the dirty table is the state table index of the flow (e.g., a hash value of a flow ID). The dirty table in the write scheduler module includes only keys, while the dirty table in the read scheduler module further includes associated data.

Further, according to an embodiment of the present disclosure, the read processor further includes a Resubmission Buffer (RB) configured to store a resubmitted packet. The read scheduler module further includes a packet buffer configured to store a packet that hits the dirty table. A packet of each flow is linked in a first linked list and a second linked list. The first linked list is configured to store a packet newly arrived on the pipeline. The second linked list is configured to store the packet requiring resubmission.

In an embodiment of the present disclosure, a packet of a flow not in the dirty table is processed without blocking, and a packet of a dirty flow that is re-submitted and blocked is opportunistically scheduled only during an idle pipeline cycle. Therefore, the packet that is re-submitted and blocked requires an RB. Under normal traffic conditions, a switch pipeline is lightly loaded, leaving sufficient idle cycles to process buffered packets. The packet newly arrived on the pipeline and hitting the dirty table in the read scheduler module is stored in the Packet Buffer (PB) of the read scheduler module.

Both the RB and the PB are queues. Once the first one of the packets in the RB gets the chance to enter the pipeline, it moves from the RB to the PB. In the PB, a packet of each flow is linked in two linked lists: the first linked list (NL) storing the packet newly arrived on the pipeline and the second linked list (RL) storing the packet requiring resubmission. Metadata of the two linked lists is maintained in the dirty table, while a link pointer of each linked list node is stored by a dedicated register set.

Further, to ensure state consistency, an order in which packets of a flow is processed by a stateful function should be the same as an order in which the packets of the flow arrive at a switch. To preserve the order of packets, the read scheduler module according to an embodiment of the present disclosure further includes an order-preserving checking module configured to schedule a packet in the packet buffer, and detect, in response to the packet in the packet buffer being scheduled, whether all packets requiring resubmission of a flow to which the packet to be scheduled belongs have already arrived at the RB and have been moved to the RL of the packet buffer.

The read scheduler module is allowed to schedule a packet of a flow in the PB only under the following conditions.

Condition (1): there is no packet of the flow in the pipeline between local read and remote write, i.e., packets of the flow have all been retransmitted to the RB.

Condition (2): all packets requiring resubmission of the flow in the RB have been moved to the PB.

Condition (2) can only be satisfied after condition (1) is satisfied. Condition (2) is guaranteed by a packet resubmission counter maintained in the dirty table. Each time the RB receives a packet requiring resubmission, the corresponding counter is incremented; each time a packet requiring resubmission is moved from the RB to the PB, the corresponding counter is decremented. A counter value of 0 indicates that condition (2) is satisfied. When a flow satisfies both conditions (1) and (2), the entire RL is inserted before the NL in preparation for scheduling, and a new RL is reset to an empty linked list.

Further, according to an embodiment of the present disclosure, two different checking schemes are designed for condition (1) to ensure that, when a packet of a flow in the PB is scheduled, all previously read packets in a stale state have already been resubmitted to the read processor. The two different checking schemes are specifically as follows.

Scheme 1

Scheme 1 is a timer-based solution, including starting a timer, and determining whether all the packets requiring resubmission have already arrived at the RB until the timer expires.

In an embodiment, the timer-based solution maintains a timer field in the dirty table of the read scheduler module. When the read scheduler module receives a returned remote write signal, the flow corresponding to the packet having the state modified is written into the dirty table, and the timer is started simultaneously. The timer is a countdown timer that continuously decrements over time. When the timer expires, it indicates that sufficient time has passed for all previously transmitted packets to return to the RB.

Since the pipeline of a data plane is non-blocking, the time a packet spends in the pipeline between local read and remote write only relates to a pipeline parameter and the number of stages between the local read and the remote write, and is a constant determinable by a compiler (measured in main clock cycles). In addition, time required for a packet to be resubmitted from the write processor to the read processor via the side ring without being blocked may also be predetermined by the compiler. The timer is initialized to a sum of these two time values when started. Thus, if no blocking occurs on the side ring, advancing the timer by one time unit every clock cycle can ensure that all the previously transmitted packets have arrived at the RB.

Thus, the timer-based solution ensures that the value of the timer only decrements during non-blocking cycles by designing a communication protocol on the side ring, guaranteeing that even when blocking occurs on the side ring, all the previously transmitted packets have arrived at the RB by the time the timer expires. The side ring may transmit three types of signals: cross-stage state write-back, a packet requiring resubmission, and a purge signal. In addition to a control tag, an address, and a data bus that are required for these three signals, a field indicating a heartbeat address is additionally added to a bus on the side ring according to an embodiment of the present disclosure.

The heartbeat address is a bitmap, where each bit corresponds to a stage on the chip. The write scheduler module continuously transmits heartbeats to the read scheduler module. Since the heartbeat of each pipeline stage occupies only one bit of the heartbeat address field, and the heartbeat address field is independent of other fields in the bus, any signal (considered a null signal when the bus is idle) can simultaneously carry any number of heartbeats. At each ring node on the side ring, a signal from the side ring competes with a signal uploaded to the ring node at a current stage. Except for null signals, which are directly discarded, other signals are stored in queue buffers in two directions, and bus arbitration is performed by a scheduler. When a signal carrying a heartbeat is blocked at a certain ring node, the read scheduler module cannot receive the heartbeat for one clock cycle. The timer in the read scheduler module advances by one time unit in response to receiving the heartbeat, achieving accurate timing. Whether an idle cycle is blocked or not does not affect timing accuracy, as a heartbeat carried by a null signal can be directly transferred to another signal when the null signal is discarded.

Scheme 2

Scheme 2 is a counter-based solution. The order-preserving checking module according to an embodiment of the present disclosure is further configured to: write, when a state of each packet is read, a sequence number of the packet into a counter table; and determine, in response to a sequence number of the packet requiring resubmission equaling the sequence number in the counter table, that all the packets requiring resubmission have already arrived at the read processor.

In the counter-based solution, a small amount of memory is added to each pipeline stage. The memory on the read processor is used for storing the counter table. When the read scheduler module receives the returned remote write signal, the flow corresponding to the packet having the state modified is written into the dirty table, and the counter table maintains a sequence number for each flow. A metadata field is used to store the sequence number for each packet, which is written and incremented when the packet enters the pipeline, and the sequence number maintained by the counter table is a maximum sequence number of stateful packets that have passed through. The sequence number of the packet requiring resubmission is compared with the sequence number in the local counter table. If the sequence number of the packet requiring resubmission is equal to the sequence number in the local counter table, it indicates that all the previously transmitted packets have returned to the RB.

It should be noted that the above two schemes correspond to two different use scenarios. The timer-based solution requires only adding an extra field to the dirty table, offering advantages in terms of chip area and power consumption. The counter-based solution is simpler to implement and does not rely on precise counting of time, offering better scalability.

In an embodiment of the present disclosure, the read processor is further configured to write, in response to a packet of a flow in the packet buffer starting to be scheduled, a purge signal into the ring node corresponding to the read processor, where the purge signal is transmitted through the side ring to the ring node corresponding to the write processor, and is downloaded to the write processor; and the write processor is further configured to remove a corresponding flow from the dirty table based on the purge signal.

It should be understood that, when the write scheduler module detects that a packet causes a state change in a flow of the packet (i.e., remote write is triggered), the flow is registered in the dirty table of the write scheduler module. When the write-back control signal arrives at a target processor via the side ring, the write-back control signal simultaneously notifies the read scheduler module on the target processor to register the flow in its own dirty table. A subsequent packet hitting the dirty table in the write scheduler module indicates a speculation failure, and the packet is uploaded to the side ring, retransmitted to the read processor, and re-enters a stateful processing flow of local read-remote write. On the read processor side, the flow registered in the dirty table of the read scheduler module serve as a safeguard to prevent a newly arrived packet of the flow from entering stateful processing. During residency of the flow, any packet of the flow that has been allowed to pass through undergoes the speculation failure and is resubmitted to the read processor. When all packets of a flow that undergo the speculation failure have been resubmitted, the read scheduler module transmits the purge signal to notify the write scheduler module to remove the flow from the dirty table of the write scheduler module. After all backlogged packets have been transmitted, the flow is removed from the local dirty table of the read scheduler module.

Since the dirty table records a hash value rather than a flow ID, there is a possibility of hash collision. In a case of hash collision, a flow that is actually not in a dirty state may hit the dirty table, which leads to erroneous blocking and resubmission, causing a certain degree of performance loss. Under typical traffic conditions and with normal hash functions, a probability of hash collision is very low, and thus an impact of hash collision on overall packet processing performance is negligible.

In an embodiment of the present disclosure, the read scheduler module includes first to third levels of state consistency. The first level of state consistency includes that: a read operation on a packet occurs subsequent to write operations on all packets prior to the packet. The second level of state consistency includes that: for a flow to which a target packet belongs, read operations on K packets following the target packet are allowed to occur prior to write operations on the K packets, and starting from the (K+1)th packet, a read operation on a packet occurs subsequent to write operations on all packets prior to the packet. The third level of state consistency includes that: an order between a read operation and a write operation on a packet is arbitrary.

The first level of state consistency may be strong consistency, the third level of state consistency may be weak consistency, and the second level of state consistency may be bounded staleness consistency. The target packet may be any packet. A state of the flow to which the target packet belongs conforms to requirements of the bounded staleness consistency. The number of packets K may be determined as desired.

Enforcing strong consistency for all applications may not be worth performance penalty. Therefore, according to an embodiment of the present disclosure, a user may be allowed to specify the level of state consistency for each application. Strong consistency means that: reading stale state is never permitted for any packet, i.e., the read operation on the packet must occur subsequent to write operations on all packets prior to the packet. Weak consistency means that: reading stale state is permitted for a packet, i.e., the order between the read operation and the write operation on the packet may be arbitrary. Bounded staleness consistency means that: reading stale state is permitted for up to K packets; and when the limit of K is reached, synchronization to the latest state is required, where K is a constant specified by the user.

It should be understood that, according to an embodiment of the present disclosure, packets may be processed by using a speculative execution technology. By default, the read processor always speculates that a stateful packet will not have its state modified. When the state of the packet is not modified, a state consistency issue is not caused. Therefore, subsequent packet processing does not need to be blocked, and thus packet processing performance of the switch chip is not affected. However, when a state of a packet needs to be modified, it indicates a speculation error. In this case, not only state data needs to be written back across stages, but also a state consistency guarantee mechanism needs to be triggered.

For strong consistency, every packet hitting the dirty table in the write scheduler module should be resubmitted. For weak consistency, when a packet causes a state change, only a new state is written back, and the flow is not registered in the dirty table, preventing resubmission of subsequent packets, which is suitable for scenarios where the state eventually converges even if stale states of some packets are read (e.g., a flow limiter).

For bounded staleness consistency, an FSM is used to guide a behavior of the write scheduler module under bounded staleness consistency, as illustrated in FIG. 6. In a “normal” state, a flow is not in the dirty table of the write scheduler module and can pass through normally without resubmission. When a packet causes a state change, the FSM transitions to a “near-expiration” state, and a decrementing counter is initialized to K. In this state, up to K packets of the flow can pass through without resubmission. When the counter reaches 0, the FSM transitions to an “expired” state, and the flow is registered in the dirty table, initiating a round of strict state synchronization. Only a purge signal from the read scheduler module can remove the flow from the dirty table of the write scheduler module and restore the state of the flow to the “normal” state.

During an actual implementation, the embodiment of the present disclosure can be based on the P4_16 language and enhance the P4_16 language by introducing a new abstract structure-a mutable table (muTable), which is equivalent to the table in P4. Compared with the table in P4, the muTable can be modified by the data plane and can therefore be used to implement a flow state table. A user-written program can apply read and write primitives to a muTable object to customize a processing logic of the stateful function. When compiling an application, the compiler determines whether a stateful function can be implemented in a single stage or across multiple stages based on complexity of the stateful function. A simple stateful function that can be implemented with an atomic action is compiled into a single stage without enabling the cross-stage data write-back function; and a complex stateful function that cannot be implemented with an atomic action is compiled into multiple stages using cross-stage data write-back.

If the stateful processing involves modifying some data (e.g., reducing the TTL field in the IPv4 protocol), packet resubmission may lead to the data being modified multiple times, causing a read-after-write conflict and thus resulting in an incorrect outcome. The compiler uses a “field renaming” technology to resolve this issue. For a field modified between local read and remote write, the compiler creates a copy of the field in the metadata. When the field is read between local read and remote write, the field is read only from a position of the copy, not from a position of the field itself that may have been modified once.

In summary, the present disclosure implements a low-cost, high-performance data plane structure to support complex stateful functions, enabling more in-network computing applications to be offloaded from a server or a middlebox to a programmable switch. Thus, communication latency in in-network computing is reduced, network bandwidth usage is decreased, a demand for a server or a middlebox device in a network system is reduced, and a programming method for in-network computing applications is simplified, thereby reducing the development, deployment, and maintenance costs of the in-network computing applications as a whole.

The speculative-execution-based stateful programmable data plane structure according to the embodiments of the present disclosure is described in detail below in conjunction with several application scenarios:

1) Application scenario 1

A Load Balancer (LB) is an indispensable function in a cloud network. Currently, more and more data centers are using a stateful LB to replace a stateless LB. In the stateful LB, a client packet is transmitted to a virtual destination IP address, and the LB assigns a physical IP address for each packet. If an incoming packet finds an existing mapping in the state table from a flow to which the incoming packet belongs to the physical IP address, the address is used for forwarding; otherwise, a policy or an algorithm is applied to select a physical IP address for the packet, and a new mapping from the flow of the packet to the physical IP address is written back into the state table.

Determining a physical server for a newly arriving flow may require a complex logic. In the related technology, controller software on the server makes a decision and then writes a result back to the flow state table. Multiple forwards and communication latency can put pressure on the packet buffer on the switch, reducing throughput. According to an embodiment of the present disclosure, a logic of the stateful LB determining a new physical IP address can be offloaded to the data plane using cross-stage write-back, effectively improving LB performance.

2) Application scenario 2

DDoS attacks (such as DNS flooding, TCP SYN flooding, and amplification attacks) have always been a significant challenge for networks. Conventional solutions based on servers or middleboxes are costly and have limited throughput. The cross-stage data write-back function provided by the present disclosure offers a high-performance DDoS detection solution that can be implemented on the data plane of the switch.

Incoming packets are classified by accessing lists (e.g., a blacklist, a whitelist, and a graylist for attack flows, normal flows, and suspicious flows, respectively), and then an analysis is performed by a detection/analysis module based on a list search result. The module may be a sketch or a series of header field checks. If a packet on the whitelist is considered suspicious, a decision module moves the corresponding flow from the whitelist to the graylist through updating the list. Other movements between lists are handled similarly.

3) Application scenario 3

Traffic shaping and policy control are crucial for enforcing Quality of Service (QoS) policies and ensuring an optimal bandwidth allocation. In this process, packets are classified based on user-defined header fields, and then evaluated based on current queue or link states using rate control or a scheduling algorithm. Subsequently, packets are queued or dropped, and the queue state is updated (i.e., written back to an evaluation module). In this case, the write-back occurs from an egress pipeline to an ingress pipeline. Since pioneering work on PIFO, many efforts have been made to make packet scheduling programmable. However, most of these efforts cannot avoid cross-stage data write-back. On today’s pipeline-based chips, these schemes have to resort to packet recirculation or approximation methods, which impacts scheduling performance or accuracy.

4) Application scenario 4

A stateful firewall can use the FSM to track and monitor active network connections and detect malicious traffic based on a flow context. Compared with a stateless firewall, the stateful firewall provides higher security and stronger attack mitigation capabilities. In the stateful firewall, the state table is checked to determine whether a packet belongs to an existing connection. When the packet belongs to the existing connection, a connection state and an associated timeout value are updated; otherwise, the packet is evaluated against predefined firewall rules to determine whether a connection should be permitted or denied, and a matching rule is applied. When a new connection is permitted, the state table is updated with information about the connection (e.g., a flow ID and a connection state). Due to complex state transitions and message passing among different modules, implementing this scheme on a pure data-plane pipeline also requires support of the cross-stage data write-back according to the present disclosure.

5) Application scenario 5

A Top-K heavy flow detection can be used for traffic-aware routing, traffic engineering, and real-time network monitoring. Since a hash table used in the Top-K heavy flow detection exceeds a storage capacity of a single pipeline stage, implementing a Top-K detection in the data plane requires distributing the table across stages. A packet needs to traverse each stage to obtain an appropriate position, and then data is written back to a selected stage. In current pipeline devices, such operations must rely on a controller or packet recirculation. The cross-stage data write-back according to the present disclosure can make this process convenient and efficient.

With the speculative-execution-based stateful programmable data plane structure according to the embodiments of the present disclosure, a simple side ring is added to the pipeline, and each pipeline stage is connected to the side ring. The data flow on the side ring is in an opposite direction to that of the pipeline, providing the fast backward communication path. The read processor reads the state required to be read of the stateful packet. When the write processor writes back the packet requiring the state modification, the state can be written back across stages. The entire process is very convenient and more efficient, and supports the complex stateful functions, reducing the development, deployment, and maintenance costs of in-network computing applications as a whole. Thus, the problems in the related technology that the pipeline techniques are unable to support the relatively complex stateful operations and incur the high development costs are solved.

An embodiment of the present disclosure further provides a programmable switch chip. The programmable switch chip includes the speculative-execution-based stateful programmable data plane structure according to the above embodiments.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in any one or N embodiments or examples. In addition, different embodiments or examples and features of different embodiments or examples described in the specification may be combined by those skilled in the art without mutual contradiction.

In addition, the terms such as “first” and “second” are used herein for purposes of description and are not intended to indicate or imply relative importance, or to implicitly show the number of technical features indicated. Thus, the feature defined with “first” and “second” may explicitly or implicitly include one or more this feature. In the description of the present disclosure, “N” means at least two, for example, two or three, unless specified otherwise.

Although embodiments of the present disclosure have been shown and described above, it should be understood that the above embodiments are just explanatory, and should not be construed to limit the present disclosure. Those skilled in the art can make changes, modifications, substitutions, and variations to the above embodiments within the scope of the present disclosure.

What is claimed is:

1. A speculative-execution-based stateful programmable data plane structure, comprising:
a plurality of stage processors forming a pipeline for data processing, wherein each of the plurality of stage processors is configured to process one pipeline stage and is configurable as a read processor or a write processor; and
a side ring comprising a plurality of ring nodes, wherein the plurality of ring nodes are connected to the plurality of stage processors in one-to-one correspondence, wherein:
any of the plurality of stage processors is configurable as the read processor or the write processor;
the read processor is configured to read a state required to be read of at least one stateful packet and speculate that the state of the stateful packet remains unchanged; and
the write processor is configured to write a state required to be written of the stateful packet, identify a packet having a state modified and requiring resubmission, upload the packet requiring resubmission to the ring node corresponding to the write processor, and transmit the packet requiring resubmission through the side ring to the ring node corresponding to the read processor, and
the read processor is further configured to download the packet requiring resubmission from the corresponding ring node.

2. The speculative-execution-based stateful programmable data plane structure according to claim 1, wherein each of the plurality of stage processors comprises a configurable scheduler module, wherein:
the configurable scheduler module of the read processor is configured as a read scheduler module;
the configurable scheduler module of the write processor is configured as a write scheduler module; and
the configurable scheduler module of a stage processor among the plurality of stage processors other than the read processor and the write processor is not activated.

3. The speculative-execution-based stateful programmable data plane structure according to claim 2, wherein each of the read scheduler module and the write scheduler module comprises:
a dirty table stored in a content-addressable memory, a key for matching in the dirty table being a state table index of a flow, wherein:
the dirty table of the write scheduler module comprises a table of keys, and the dirty table of the read scheduler module comprises a table of keys and corresponding data; and
the write scheduler module is configured to write a flow corresponding to the packet having the state modified into the dirty table, and transmit a write-back control signal through the side ring to the read scheduler module, and
the read scheduler module is configured to write the flow corresponding to the packet having the state modified into the dirty table based on the write-back control signal.

4. The speculative-execution-based stateful programmable data plane structure according to claim 3, wherein:
the read processor further comprises:
a resubmission buffer configured to store a resubmitted packet; and
the read scheduler module further comprises:
a packet buffer configured to store a packet that hits the dirty table, wherein a packet of each flow is linked in a first linked list and a second linked list, the first linked list being configured to store a packet newly arrived on the pipeline, and the second linked list being configured to store the packet requiring resubmission; and
an order-preserving checking module configured to schedule a packet in the packet buffer, and detect, in response to the packet in the packet buffer being scheduled, whether all packets requiring resubmission of a flow to which the packet to be scheduled belongs have already arrived at the resubmission buffer and have been moved to the second linked list of the packet buffer.

5. The speculative-execution-based stateful programmable data plane structure according to claim 4, wherein the order-preserving checking module is further configured to:
start a timer, and determine whether all the packets requiring resubmission have already arrived at the resubmission buffer until the timer expires.

6. The speculative-execution-based stateful programmable data plane structure according to claim 5, wherein:
a bus of the side ring is configured with a heartbeat address field, wherein the heartbeat address field is independent of other fields on the bus, and each pipeline stage occupies one bit of the heartbeat address field, and writes a signal carrying a heartbeat into the heartbeat address field; and
the timer is configured to advance by one time unit in response to receiving the signal carrying the heartbeat transmitted from the corresponding write processor.

7. The speculative-execution-based stateful programmable data plane structure according to claim 4, wherein the order-preserving checking module is further configured to:
write, when a state of each packet is read, a sequence number of the packet into a counter table; and
determine, in response to a sequence number of the packet requiring resubmission equaling the sequence number in the counter table, that all the packets requiring resubmission have already arrived at the resubmission buffer.

8. The speculative-execution-based stateful programmable data plane structure according to claim 4, wherein:
the read processor is further configured to write, in response to a packet of a flow in the packet buffer starting to be scheduled, a purge signal into the corresponding ring node, wherein the purge signal is transmitted through the side ring to the ring node corresponding to the write processor, and is downloaded to the write processor; and
the write processor is further configured to remove a corresponding flow from the dirty table based on the purge signal.

9. The speculative-execution-based stateful programmable data plane structure according to claim 4, wherein the read scheduler module comprises first to third levels of state consistency, wherein:
the first level of state consistency comprises that: a read operation on a packet occurs subsequent to write operations on all packets prior to the packet;
the second level of state consistency comprises that: for a flow to which a target packet belongs, read operations on K packets following the target packet are allowed to occur prior to write operations on the K packets, and starting from a (K+1)th packet, a read operation on a packet occurs subsequent to write operations on all packets prior to the packet; and
the third level of state consistency comprises that: an order between a read operation and a write operation on a packet is arbitrary.

10. A programmable switch chip, comprising a speculative-execution-based stateful programmable data plane structure, the speculative-execution-based stateful programmable data plane structure comprising:
a plurality of stage processors forming a pipeline for data processing, wherein each of the plurality of stage processors is configured to process one pipeline stage and is configurable as a read processor or a write processor; and
a side ring comprising a plurality of ring nodes, wherein the plurality of ring nodes are connected to the plurality of stage processors in one-to-one correspondence, wherein:
any of the plurality of stage processors is configurable as the read processor or the write processor;
the read processor is configured to read a state required to be read of at least one stateful packet and speculate that the state of the stateful packet remains unchanged; and
the write processor is configured to write a state required to be written of the stateful packet, identify a packet having a state modified and requiring resubmission, upload the packet requiring resubmission to the ring node corresponding to the write processor, and transmit the packet requiring resubmission through the side ring to the ring node corresponding to the read processor, and
the read processor is further configured to download the packet requiring resubmission from the corresponding ring node.

11. The programmable switch chip according to claim 10, wherein each of the plurality of stage processors comprises a configurable scheduler module, wherein:
the configurable scheduler module of the read processor is configured as a read scheduler module;
the configurable scheduler module of the write processor is configured as a write scheduler module; and
the configurable scheduler module of a stage processor among the plurality of stage processors other than the read processor and the write processor is not activated.

12. The programmable switch chip according to claim 11, wherein each of the read scheduler module and the write scheduler module comprises:
a dirty table stored in a content-addressable memory, a key for matching in the dirty table being a state table index of a flow, wherein:
the dirty table of the write scheduler module comprises a table of keys, and the dirty table of the read scheduler module comprises a table of keys and corresponding data; and
the write scheduler module is configured to write a flow corresponding to the packet having the state modified into the dirty table, and transmit a write-back control signal through the side ring to the read scheduler module, and
the read scheduler module is configured to write the flow corresponding to the packet having the state modified into the dirty table based on the write-back control signal.

13. The programmable switch chip according to claim 12, wherein:
the read processor further comprises:
a resubmission buffer configured to store a resubmitted packet; and
the read scheduler module further comprises:
a packet buffer configured to store a packet that hits the dirty table, wherein a packet of each flow is linked in a first linked list and a second linked list, the first linked list being configured to store a packet newly arrived on the pipeline, and the second linked list being configured to store the packet requiring resubmission; and
an order-preserving checking module configured to schedule a packet in the packet buffer, and detect, in response to the packet in the packet buffer being scheduled, whether all packets requiring resubmission of a flow to which the packet to be scheduled belongs have already arrived at the resubmission buffer and have been moved to the second linked list of the packet buffer.

14. The programmable switch chip according to claim 13, wherein the order-preserving checking module is further configured to:
start a timer, and determine whether all the packets requiring resubmission have already arrived at the resubmission buffer until the timer expires.

15. The programmable switch chip according to claim 14, wherein:
a bus of the side ring is configured with a heartbeat address field, wherein the heartbeat address field is independent of other fields on the bus, and each pipeline stage occupies one bit of the heartbeat address field, and writes a signal carrying a heartbeat into the heartbeat address field; and
the timer is configured to advance by one time unit in response to receiving the signal carrying the heartbeat transmitted from the corresponding write processor.

16. The programmable switch chip according to claim 13, wherein the order-preserving checking module is further configured to:
write, when a state of each packet is read, a sequence number of the packet into a counter table; and
determine, in response to a sequence number of the packet requiring resubmission equaling the sequence number in the counter table, that all the packets requiring resubmission have already arrived at the resubmission buffer.

17. The programmable switch chip according to claim 13, wherein:
the read processor is further configured to write, in response to a packet of a flow in the packet buffer starting to be scheduled, a purge signal into the corresponding ring node, wherein the purge signal is transmitted through the side ring to the ring node corresponding to the write processor, and is downloaded to the write processor; and
the write processor is further configured to remove a corresponding flow from the dirty table based on the purge signal.

18. The programmable switch chip according to claim 13, wherein the read scheduler module comprises first to third levels of state consistency, wherein:
the first level of state consistency comprises that: a read operation on a packet occurs subsequent to write operations on all packets prior to the packet;
the second level of state consistency comprises that: for a flow to which a target packet belongs, read operations on K packets following the target packet are allowed to occur prior to write operations on the K packets, and starting from a (K+1)th packet, a read operation on a packet occurs subsequent to write operations on all packets prior to the packet; and
the third level of state consistency comprises that: an order between a read operation and a write operation on a packet is arbitrary.
